(19) United States
(12) Patent Application Publication
(10) Pub. No.: US 2020/0173166 A1
(43) Pub. Date: Jun. 4, 2020

(54) ADHESIVE TAPE FOR HOME INSULATION AND SELF-ADHESIVE THERMAL INSULATION PRODUCT

(71) Applicant: Coroplast Tape Corporation, Rock Hill, SC (US)

(72) Inventors: Alexander CHILDERS, Rock Hill, SC (US); Jeffrey PASOUR, Dallas, NC (US)

(21) Appl. No.: 16/666,930

(22) Filed: Oct. 29, 2019

Related U.S. Application Data
(60) Provisional application No. 62/774,944, filed on Dec. 4, 2018.

(51) Int. Cl. E04B 1/76

(52) U.S. Cl. CPC E04B 1/7666; B32B 27/08

(57) ABSTRACT

A self-adhesive thermal insulation product is provided. The self-adhesive thermal insulation product includes a fibrous polymeric backing, an adhesive layer, an insulation batt attached to the central adhesive portion, and a release layer. An adhesive tape for home insulation is also provided. The adhesive tape for home insulation includes a fibrous polymeric backing, an adhesive layer on a front surface of the fibrous polymeric backing, and a release layer. An adhesive seal is also provided.

### CROSS REFERENCE TO RELATED APPLICATION

This application claims priority to U.S. Provisional Application No. 62/774,944 filed Dec. 4, 2018, which is incorporated by reference herein in its entirety.

### TECHNICAL FIELD

The present disclosure is related generally to an improved method of installing home insulation, and more particularly to an adhesive product for home insulation applications.

### BACKGROUND

Properly installed home insulation may reduce heat loss during winter months and promote more efficient cooling during the summer, lowering heating and cooling costs. Home insulation may take the form of loose fill, batts, rolls, board, and spray products made from fiberglass, mineral wool, cellulose and/or foam. Some insulation products may include a thin facing or backing material with flaps that can be stapled to wall studs or other frame members to hold the insulation in place. Unfaced or unbacked insulation may be held in place by a friction fit or with mechanical supports referred to as tiger teeth or lightning rods. Home insulation may be employed between wall studs of residential or commercial buildings and/or for other applications. In a crawl space or attic, the insulation is commonly exposed within the space. The direct contact often required to install widely-used fiberglass insulation can be problematic since fiberglass is a known skin irritant. Due to poor hanging practices and/or damage from moisture, insects, or vermin, insulation may lose effectiveness and become an eyesore. Thus, improved installation products and practices would be beneficial.

### BRIEF SUMMARY

According to one aspect, a self-adhesive thermal insulation product is provided that includes a fibrous polymeric backing, an adhesive layer on a front surface of the fibrous polymeric backing, the adhesive layer including a central adhesive portion and side adhesive portions, an insulation batt attached to the central adhesive portion, and a release layer comprising side release portions attached to the side adhesive portions. When the release layer is removed, the side adhesive portions are attachable to structural support members. According to one embodiment, the self-adhesive thermal insulation product further includes a functional layer between the fibrous polymeric backing and the adhesive layer, the functional layer having one or more characteristics selected from the group consisting of: abrasion resistance, rigidity, sound-dampening capacity, flame retardancy, vapor impermeability, and moisture impermeability. According to one embodiment, the functional layer includes one or more of a dispersant rubber polymer, a thermoplastic polymer, or a thermosetting polymer. According to one embodiment, the thermoplastic polymer includes one or more of ethylene-vinyl acetate (EVA), polyethylene (PE), polystyrene (PS), polypropylene (PP), polyvinyl chloride (PVC), linear low-density polyethylene (LLDPE), low-density polyethylene (LDPE), high-density polyethylene (HDPE), or polyethylene (PE). According to one embodiment, the insulation batt further includes a reflective layer on an opposing surface not attached to the central adhesive portion. According to one embodiment, the reflective layer includes a metal foil or white film. According to one embodiment, the fibrous polymeric backing includes a polyester. According to one embodiment, the polyester includes polyethylene terephthalate (PET). According to one embodiment, the fibrous polymeric backing includes nonwoven fibers, woven fibers, or a combination thereof. According to one embodiment, the adhesive layer includes one or more of UV-crosslinkable polymer, acrylic, acrylate or acetate. According to one embodiment, the adhesive layer includes a basis weight in a range from about 100 g/m² to about 200 g/m². According to one embodiment, the central adhesive portion has a nominal width between the side adhesive portions of about 16 in (41 cm). According to one embodiment, each of the side adhesive portions has a nominal width of about 1 in (2.5 cm).

According to one aspect, an adhesive tape for home insulation is provided that includes a fibrous polymeric backing, an adhesive layer on a front surface of the fibrous polymeric backing, a release layer comprising central and side release portions, the central release portion being attached to a central adhesive portion of the adhesive layer, and the side release portions being attached to side adhesive portions of the adhesive layer. When the central release portion is removed, the central adhesive portion are attachable to an insulation batt. When the side release portions are removed, the side adhesive portions are attachable to structural support members. According to one embodiment, the release layer is perforated or scored to define the central and side release portions. According to one embodiment, the release layer is a multi-piece release layer, the central and side release portions being separated. According to one embodiment, the adhesive tape further includes a functional layer between the fibrous polymeric backing and the adhesive layer, the functional layer having one or more characteristics selected from the group consisting of: abrasion resistance, rigidity, sound-dampening capacity, flame retardancy, vapor impermeability, and moisture impermeability. According to one embodiment, the functional layer includes a thermoplastic polymer. According to one embodiment, the thermoplastic polymer includes one or more of ethylene-vinyl acetate (EVA), polyethylene (PE), polystyrene (PS), polypropylene (PP), polyvinyl chloride (PVC), linear low-density polyethylene (LLDPE), low-density polyethylene (LDPE), high-density polyethylene (HDPE), or polyethylene (PE). According to one embodiment, the fibrous polymeric backing includes a polyester. According to one embodiment, the polyester includes polyethylene terephthalate (PET). According to one embodiment, the fibrous polymeric backing includes woven fibers. According to one embodiment, the fibrous polymeric backing includes nonwoven fibers. According to one embodiment, the adhesive layer includes an acrylate or acetate. According to one embodiment, the adhesive layer includes a UV-crosslinkable polymer, a foam-based UV-acrylic, or a combination thereof. According to one embodiment, the adhesive layer includes a basis weight in a range from about 100 g/m² to about 200 g/m². According to one embodiment, the central adhesive portion has a nominal width between the side adhesive portions of about 16 in (41 cm). According to one embodiment, each of the side adhesive portions has a nominal width of about 1 in (2.5 cm).

According to one aspect, an adhesive tape for home insulation is provided that includes a fibrous polymeric backing, a functional layer on a front surface of the fibrous polymeric backing, the functional layer having one or more characteristics selected from the group consisting of: abrasion resistance, rigidity, sound-dampening capacity, flame retardancy, vapor impermeability, and moisture impermeability, an adhesive layer on the functional layer, the adhesive layer comprising a central adhesive portion and side adhesive portions, and a release layer attached to the adhesive layer and overlying the central adhesive and side adhesive portions. When the release layer is removed, the central adhesive portion is attachable to an insulation batt and the side adhesive portions are attachable to structural support members. According to one embodiment, the release layer is perforated, scored, or multi-piece so as to include central and side release portions, the central release portion being attached to the central adhesive portion and the side release portions being attached to the side adhesive portions. According to one embodiment, the functional layer includes one or more of a dispersant rubber polymer, a thermoplastic polymer, or a thermosetting polymer. According to one embodiment, the thermoplastic polymer includes ethylene-vinyl acetate (EVA), polyethylene (PE), polystyrene (PS), polypropylene (PP), polyvinyl chloride (PVC), linear low-density polyethylene (LLDPE), low-density polyethylene (LDPE), high-density polyethylene (HDPE), or polyethylene (PE). According to one embodiment, the fibrous polymeric backing includes a polyester. According to one embodiment, the polyester includes polyethylene terephthalate (PET). According to one embodiment, the fibrous polymeric backing includes nonwoven fibers, woven fibers, or a combination thereof. According to one embodiment, the adhesive layer includes a UV-crosslinkable polymer, a foam-based UV-acrylic, or a combination thereof. According to one embodiment, the adhesive layer includes a basis weight in a range from about 100 g/m² to about 200 g/m². According to one embodiment, the central adhesive portion has a nominal width between the side adhesive portions of about 16 in (41 cm). According to one embodiment, each of the side adhesive portions has a nominal width of about 1 in (2.5 cm).

According to one aspect, an adhesive seal is provided that includes an elastomeric backing comprising an adhesive coating on a front surface thereof, an expandable hole in the elastomeric backing, a release layer attached to part or all of the adhesive coating, and, optionally, a radial cut in the release layer. The expandable hole and surrounding elastomeric backing are capable of stretching to fit around one or more components. According to one embodiment, the elastomeric backing includes an elastomeric polymer selected from the group consisting of butyl rubber (isobutylene-isoprene), isoprene rubber, natural rubber, and synthetic rubber.

According to one aspect, a ridge venting system for an attic is provided that includes a self-adhesive thermal insulation product that, in turn, includes a fibrous polymeric backing, an adhesive layer on a front surface of the fibrous polymeric backing, and the adhesive layer including a central adhesive portion attached to an insulation batt and side adhesive portions attachable to adjacent roof rafters to secure the insulation batt in a cavity there between. The insulation batt includes a reflective layer on an opposing side not attached to the central adhesive portion. The reflective layer faces and is spaced apart from roof sheathing so as to define a pathway for airflow. According to one embodiment, the self-adhesive thermal insulation product further includes a functional layer between the fibrous polymeric backing and the adhesive layer, the functional layer having one or more characteristics selected from the group consisting of: abrasion resistance, rigidity, sound-dampening capacity, flame retardancy, vapor impermeability, and moisture impermeability.

According to one aspect, a crawl space insulation system is provided that includes a self-adhesive thermal insulation product that, in turn, includes a fibrous polymeric backing, an adhesive layer on a front surface of the fibrous polymeric backing, the adhesive layer including a central adhesive portion attached to an insulation batt and side adhesive portions attachable to adjacent floor joists to secure the insulation batt into a cavity there between. According to one embodiment, the side adhesive portions are attached to front surfaces of the floor joists such that a back surface of the fibrous polymeric backing defines a crawl space ceiling. According to one embodiment, the self-adhesive thermal insulation product further includes a functional layer between the fibrous polymeric backing and the adhesive layer, the functional layer having one or more characteristics selected from the group consisting of: abrasion resistance, rigidity, sound-dampening capacity, flame retardancy, vapor impermeability, and moisture impermeability.

According to one aspect, a method for installing thermal insulation is provided and includes the steps of providing an adhesive tape as provided herein, removing the release layer from the adhesive layer, attaching an insulation batt to the central adhesive portion, and attaching the side adhesive portions to structural support members, thereby installing the thermal insulation.

According to another aspect, a method for installing thermal insulation is provided and includes the steps of providing an adhesive tape as provided herein, removing the central release portion to expose the central adhesive portion, attaching an insulation batt to the central adhesive portion, removing the side release layers to expose the side adhesive portions, and attaching the side adhesive portions to structural support members, thereby installing the thermal insulation.

According to one aspect, a method for installing thermal insulation is provided and includes the steps of providing an adhesive tape as provided herein, removing the side release portions to expose the side adhesive portions, and attaching the side adhesive portions to structural support members, thereby installing the self-adhesive thermal insulation product.

### BRIEF DESCRIPTION OF THE DRAWINGS

FIG. 1 is a cross-sectional schematic of an exemplary self-adhesive thermal insulation product.

FIG. 2 is a cross-sectional schematic of the self-adhesive thermal insulation product of FIG. 1 attached to structural support members.

FIGS. 3A and 3B are cross-sectional schematics of an exemplary adhesive tape for home insulation, where different embodiments of the release layer are illustrated.

FIG. 4 is a flow chart showing a method of installing insulation according to one embodiment.

FIG. 5 is a flow chart showing a method of installing insulation according to another embodiment.

FIG. 6 is a flow chart showing a method of installing insulation according to another embodiment.

FIG. 7 is a schematic of an adhesive seal that may be used with the self-adhesive thermal insulation product.

### DETAILED DESCRIPTION

Described herein are adhesive tape and self-adhesive thermal insulation products that may enable home insulation to be installed more easily and more effectively.

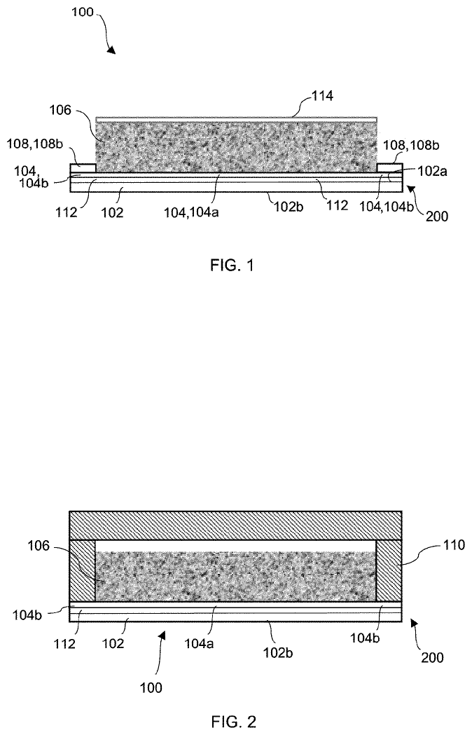

Referring to FIG. 1, a self-adhesive thermal insulation product 100 includes a fibrous polymeric backing 102 with an adhesive layer 104 on a front surface 102a thereof, where the adhesive layer 104 includes a central adhesive portion 104a and side adhesive portions 104b. The central adhesive portion 104a is situated between the side adhesive portions 104b, as shown in FIG. 1. An insulation batt 106 is attached to the central adhesive portion 104a, and a release layer 108 comprising side release portions 108b is attached to the side adhesive portions 104b. When the side release portions 108b are removed, the side adhesive portions 104b are exposed and may be attached to structural support members 110 of a building, as illustrated in FIG. 2. The structural support members 110 are typically floor joists, ceiling joists, roof rafters, or wall studs fabricated from wood or metal. Thus, the thermal insulation product 100 may be securely and easily installed without using staples or other mechanical supports.

The insulation batt 106 may include any insulating material having suitable properties (e.g., a desired R-value) for the intended application. Suitable insulating materials may include fiber glass, mineral wool, cellulose, and/or foam. Typically the insulation batt 106 is fibrous and flexible. The insulation batt 106 may have a width determined by a standard spacing between the structural support members 110 used in building construction, such as 16 inches or 24 inches. Such insulation batts 106 are commercially available from a number of suppliers.

The adhesive layer 104 may include a pressure-sensitive adhesive.

Advantageously, the adhesive layer 104 is characterized by a high tack and strong adhesion, even to dirty or porous structural surfaces (e.g., wood) found in crawl spaces and attics, for example. The adhesive layer 104 may include one or more of a hot melt adhesive. Suitable hot melt adhesives include, but are not limited to, UV-crosslinkable polymers and acrylic polymers (foamed-crosslinkable). In one example, the adhesive layer may include an acrylate or acetate adhesive. Suitable exemplary adhesive formulations are described in U.S. Patent Application Publication No. 2016/0168427, which is hereby incorporated by reference in its entirety. In another example, the hot melt adhesive may include a synthetic or natural rubber. According to one embodiment, the adhesive layer 104 is applied over an entirety of the length and width of the fibrous polymeric backing 102.

Due to the high tack, the adhesive layer 104 may be covered in full or in part by a release layer 108 configured for easy detachment from the adhesive layer 104. The release layer 108 may be described as being attached to or “removably attached to” the adhesive layer 104. Removal of the release layer 108 allows part or all of the adhesive layer 104 to be exposed for use. In the example of FIG. 1, the release layer 108 includes side release portions 108b which are attached to the side adhesive portions 104b of the adhesive layer 104. Prior to installation of the thermal insulation product 100, the release layer 108 (e.g., side release portions 108b) may be removed from the adhesive layer 104. The release layer 108 may include a polymer, such as a silicone-coated polymer, polyethylene, polyolefin, or a combination thereof. Alternatively, the release layer 108 may be paper-based. A release layer may not be required on the adhesive layer 104 (optional).

The self-adhesive thermal insulation product 100 may further include a functional layer 112 between the fibrous polymeric backing 102 and the adhesive layer 104. The functional layer 112 may be designed to provide abrasion resistance, rigidity, sound-dampening capacity, flame retardance, vapor impermeability, and/or moisture impermeability, thereby improving the performance of the fibrous polymeric backing 102.

According to one embodiment, the functional layer 112 includes one or more polymers. Suitable polymers include a dispersant rubber polymer, a thermoplastic polymer, a thermosetting polymer, or a combination thereof. According to a particular embodiment, the dispersant rubber polymer may be solvent based or water based. According to yet another embodiment, the dispersant rubber polymer is acrylic dispersed. Suitable thermoplastic polymers include, but are not limited to, ethylene-vinyl acetate (EVA) or a copolymer of ethylene and vinyl acetate that is sometimes referred to as poly(ethylene-vinyl acetate) (PEVA). The thermoplastic polymer may include one or more polyethylene (PE), polystyrene (PS), polypropylene (PP), or a vinyl polymer such as polyvinyl chloride (PVC). According to a particular embodiment, the thermoplastic polymer is linear low-density polyethylene (LLDPE), low-density polyethylene (LDPE), high-density polyethylene (HDPE), polyethylene (PE), or a combination thereof. According to one embodiment, a suitable ratio weight ratio of the functional layer 112 to the adhesive layer 104 may lie in a ratio range from about 40:60 to about 60:40. According to one embodiment, a suitable ratio weight ratio of the functional layer 112 to the adhesive layer 104 may lie in a ratio of about 50:50.

The fibrous polymeric backing 102 may be formed from woven polymeric fibers, nonwoven polymeric fibers, or a combination thereof. The polymeric fibers may include a polyester such as polyethylene terephthalate (PET). For example, the fibrous polymeric backing may be formed from commercially available PET cloth. According to one embodiment, the fibrous polymeric backing 102 may have a multilayer structure where two or more fibrous backings are laminated together. According to one embodiment, a fibrous polymeric backing including woven polymeric fibers may be laminated to a fibrous polymeric backing including nonwoven polymeric fibers. A hot melt adhesive may be used for lamination. The fibrous polymeric backing 102 not only functions as a carrier for the adhesive layer 104, but may also impart thermal and dimensional stability to the insulation product 100, which can be critical in cold and hot environments. Sufficient thermal and dimensional stability may prevent or inhibit delamination of the product despite variable environmental temperatures.

Depending on the intended application, the insulation batt 106 may further include a reflective layer 114 on an exposed surface not attached to (and opposite to) the central adhesive portion 104a. The reflective layer 114 may include a metal foil or white film effective for reflecting radiant heat. The reflective layer may be perforated to include microholes that allow gases to pass through, but not moisture. Such a reflective layer may be particularly useful for attic applications, such as the ridge vent application described below. Suitable insulation batts including such a reflective layer may be obtained from various commercial providers, such as Rockwool of Milton, Ontario, Canada.

According to one embodiment, the adhesive layer 104 may be continuous over the front side 102a of the fibrous polymeric backing 102, such that the central adhesive portion 104a and the side adhesive portions 104b are continuous. According to a particular embodiment, the central adhesive portion 104a is not typically physically discontinuous or separate from the side adhesive portions 104b (although such separation is possible). Accordingly, the central adhesive portion 104a and the side adhesive portions 104b typically include the same pressure-sensitive adhesive. The portions 104a,104b of the adhesive layer 104 may be distinguished by their functions, where, in use, the central adhesive portion 104a is attached to the insulation batt 106 and the side adhesive portions 104b are attached to structural support members 110, as illustrated in FIG. 2.

The central adhesive portion 104a may have a nominal width of about 16 in (41 cm) or about 24 in (61 cm), consistent with the width of the insulation batt 106 and the distance between the structural support members 110, while each of the side adhesive portions 104b may have a nominal width of about 1 in (2.5 cm). Accordingly, the fibrous polymeric backing 102 and the adhesive layer 104, which is typically applied over an entirety of the front surface 102a of the backing 102, may have a nominal width of about 18 in (46 cm) or about 26 in (66 cm). According to one embodiment, the fibrous polymeric backing and the adhesive layer 104 applied thereon may have any desired width, but for home insulation applications, as set forth above, widths in a range from about 10 in (25 cm) to about 30 in (76 cm) (e.g., from about 15 in (38 cm) to about 25 in (64 cm), or from about 16 in (41 cm) to about 24 in (61 cm)) may be of greatest utility. The length of both the fibrous polymeric backing 102 and the adhesive layer 104 may range from about one meter to as large as several thousand meters (e.g., if the insulation product 100 is packaged as a roll). Typically, the self-adhesive thermal insulation product 100 is cut to the desired length during installation.

If desired, the insulation batt may be provided separately and attached to an adhesive backing at the time of (or at some point prior to) installation. According to such an embodiment, the adhesive product may take the form of a large-format adhesive tape that may be attached to an insulation batt having any of the characteristics described above.

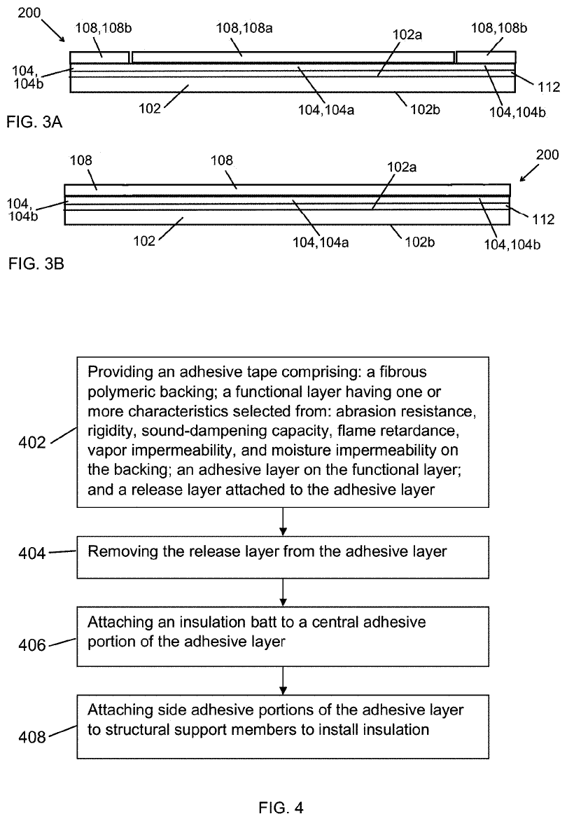

Referring to the cross-sectional schematics of FIGS. 3A and 3B, the large-format adhesive tape 200 includes a fibrous polymeric backing 102 with an adhesive layer 104 on a front surface 102a thereof. The adhesive layer 104 includes a central adhesive portion 104a and side adhesive portions 104b, as described above. The adhesive layer 104 may include a pressure-sensitive adhesive characterized by a high tack and strong adhesion, even to dirty or porous structural surfaces (e.g., wood) found in crawl spaces and attics, for example. The adhesive layer may include one or more of a hot melt adhesive. Suitable hot melt adhesives include, but are not limited to, UV-crosslinkable polymers and acrylic polymers (foamed-crosslinkable). Suitable exemplary adhesive formulations are described in U.S. Patent Application Publication No. 2016/0168427, as mentioned above, and incorporated by reference herein. In another example, the hot melt adhesive may include a synthetic or natural rubber. According to such an embodiment, the adhesive layer 104 is applied over an entirety of the length and width of the fibrous polymeric backing 102.

Due to the high tack, the adhesive layer 104 may be covered in full or in part by a release layer 108 configured for easy detachment from the adhesive layer 104, as shown in FIGS. 3A and 3B. The release layer 108 may be described as being attached to or “removably attached to” the adhesive layer 104. Removal of the release layer 108 allows part or all of the adhesive layer 104 to be exposed for use. According to one embodiment, as shown in FIG. 3A, the release layer 108 includes central and side release portions 108a,108b attached to the central and side adhesive portions 104a,104b, respectively, of the adhesive layer 104. It may be advantageous to be able to remove the central release portion 104a separately from the side release portions 104b (e.g., to attach the insulation batt 106 prior to installing the insulation product). Accordingly, the release layer 108 may be scored or perforated to define the central and side release portions 108a,108b and to facilitate separate removal. Alternatively, the release layer 108 may be a multi-piece release layer including fully separated central and side release portions 108a,108b for even easier separate removal, as illustrated in FIG. 3A. Another option is that the release layer 108 is not perforated, scored, or multi-piece and may instead be continuous, as shown in FIG. 3B, in which case removal of the release layer occurs in a single step. The release layer 108 may include a polymer, such as a silicone-coated polymer, polyethylene, polyolefin, or a combination thereof. Alternatively, the release layer 108 may be paper-based. While a release layer is beneficial due to the high tack of the adhesive layer 104, a release layer may not be required in all embodiments.

The adhesive tape 200 may further include a functional layer 112 between the fibrous polymeric backing 102 and the adhesive layer 104, as described above, where the functional layer is designed to provide abrasion resistance, rigidity, sound-dampening capacity, flame retardance, vapor impermeability, and/or moisture impermeability, thereby improving the performance of the fibrous polymeric backing 102.

The functional layer 112 may include one or more polymers. Suitable polymers include a dispersant rubber polymer, a thermoplastic polymer, or a thermosetting polymer. According to a particular embodiment, the dispersant rubber polymer may be solvent based or water based. According to yet another embodiment, the dispersant rubber polymer is acrylic dispersed. Suitable thermoplastic polymers include, but are not limited to, ethylene-vinyl acetate (EVA) or a copolymer of ethylene and vinyl acetate that is sometimes referred to as poly(ethylene-vinyl acetate) (PEVA). The thermoplastic polymer may include one or more polyethylene (PE), polystyrene (PS), polypropylene (PP), or a vinyl polymer such as polyvinyl chloride (PVC). According to a particular embodiment, the thermoplastic polymer is linear low-density polyethylene (LLDPE), low-density polyethylene (LDPE), high-density polyethylene (HDPE), polyethylene (PE), or a combination thereof. According to one embodiment, a suitable ratio weight ratio of the functional layer 112 to the adhesive layer 104 may lie in a ratio range from about 40:60 to about 60:40. According to one embodiment, a suitable ratio weight ratio of the functional layer 112 to the adhesive layer 104 may lie in a ratio of about 50:50.

The fibrous polymeric backing 102 may be formed from woven polymeric fibers, nonwoven polymeric fibers, or a combination thereof. The polymeric fibers may include a polyester such as polyethylene terephthalate (PET). According to one embodiment, the fibrous polymeric backing may be formed from commercially available PET cloth. According to one embodiment, the fibrous polymeric backing 102 may have a multilayer structure where two or more fibrous backings are laminated together. According to a particular embodiment, a fibrous polymeric backing comprising woven polymeric fibers may be laminated to a fibrous polymeric backing comprising nonwoven polymeric fibers. A hot melt adhesive may be used for lamination. The fibrous polymeric backing 102 not only functions as a carrier for the adhesive layer 104, but may also impart thermal and dimensional stability to the insulation product 100, which can be critical in cold and hot environments. Sufficient thermal and dimensional stability may prevent or inhibit delamination of the product despite changing or extreme environmental temperatures.

According to one embodiment, the adhesive layer 104 may be continuous over the front side 102a of the fibrous polymeric backing 102, such that the central adhesive portion 104a and the side adhesive portions 104b are continuous. According to such an embodiment, the central adhesive portion 104a is not typically physically discontinuous or separate from the side adhesive portions 104b (although such separation is possible). Accordingly, the central adhesive portion 104a and the side adhesive portions 104b typically include the same pressure-sensitive adhesive. The portions 104a,104b of the adhesive layer 104 are distinguished by their functions, where, in use, the central adhesive portion 104a may be attached to an insulation batt (e.g., as described above) and the side adhesive portions 104b may be attached to structural support members.

The central adhesive portion 104a may have a nominal width of about 16 in (41 cm) or about 24 in (61 cm), consistent with the width of the insulation batt and the distance between the structural support members, while each of the side adhesive portions 104b may have a nominal width of about 1 in (2.5 cm). Accordingly, the fibrous polymeric backing 102 and the adhesive layer 104, which is typically applied over an entirety of the front surface 102a of the backing 102, may have a nominal width of about 18 in (46 cm) or about 26 in (66 cm). According to one embodiment, the fibrous polymeric backing and the adhesive layer 104 applied thereon could have any desired width, but for home insulation applications, as set forth above, it is expected that widths in a range from about 10 in (25 cm) to about 30 in (76 cm) (e.g., from about 15 in (38 cm) to about 25 in (64 cm), or from about 16 in (41 cm) to about 24 in (61 cm)) may be of greatest utility. The length of both the fibrous polymeric backing 102 and the adhesive layer 104 may range from about one meter to as large as several thousand meters (e.g., if the adhesive tape 200 is packaged as a roll). Typically, the adhesive tape 200 is cut to the desired length during installation.

The adhesive tape 200 and self-adhesive thermal insulation product 100 described herein may be used in any of a number of home insulation applications. The products provided herein may be beneficial for insulating crawl spaces and forming ridge venting systems in attics. The products as provided herein may also be used for insulating walls as well as other areas of residential and commercial buildings.

Referring again to FIG. 2, a crawl space insulation system or a wall insulation system may include a self-adhesive thermal insulation product 100 comprising a fibrous polymeric backing 102 with an adhesive layer 104 on a front surface 102a of the backing 102. The adhesive layer 104 may include a central adhesive portion 104a attached to an insulation batt 106 and side adhesive portions 104b attachable to adjacent floor joists or wall studs 110 to secure the insulation batt 106 into a cavity between the joists/studs 110. The side adhesive portions may be attached to front surfaces of the floor joists or wall studs 110 such that a back surface 102b of the fibrous polymeric backing 102 defines a continuous surface, such as a crawl space ceiling.

According to another embodiment, a ridge venting system for an attic may include a self-adhesive thermal insulation product 100 comprising a fibrous polymeric backing 102 with an adhesive layer 104 on a front surface 102a of the backing 102, as shown in FIG. 1. The adhesive layer 104 may include a central adhesive portion 104a attached to an insulation batt 106 and side adhesive portions 104b attachable to adjacent roof rafters to secure the insulation batt into a cavity there between. According to such an embodiment, the insulation batt 106 may further include a reflective layer 114 on an exposed surface not attached to the central adhesive portion 104a for reflecting away radiant heat. In use, the reflective layer 114 may face and be spaced apart from roof sheathing so as to define a pathway for air flow.

Also described in this disclosure is a method for installing thermal insulation. Referring to the flow chart of FIG. 4, the method includes, according to one embodiment, providing 402 an adhesive tape comprising: a fibrous polymeric backing; an optional functional layer having one or more characteristics selected from: abrasion resistance, rigidity, sound-dampening capacity, flame retardance, vapor impermeability, and moisture impermeability on a front surface of the fibrous polymeric backing; an adhesive layer on the functional layer; and a release layer attached to the adhesive layer. The release layer may be removed 404 from the adhesive layer in a single step, and an insulation batt may be attached 406 to a central adhesive portion of the adhesive layer. After attachment of the insulation batt, side adhesive portions on either side of the central adhesive portion may be attached 408 to structural support members to install the thermal insulation. Prior to removing the release layer, the adhesive tape may be cut to a desired length.

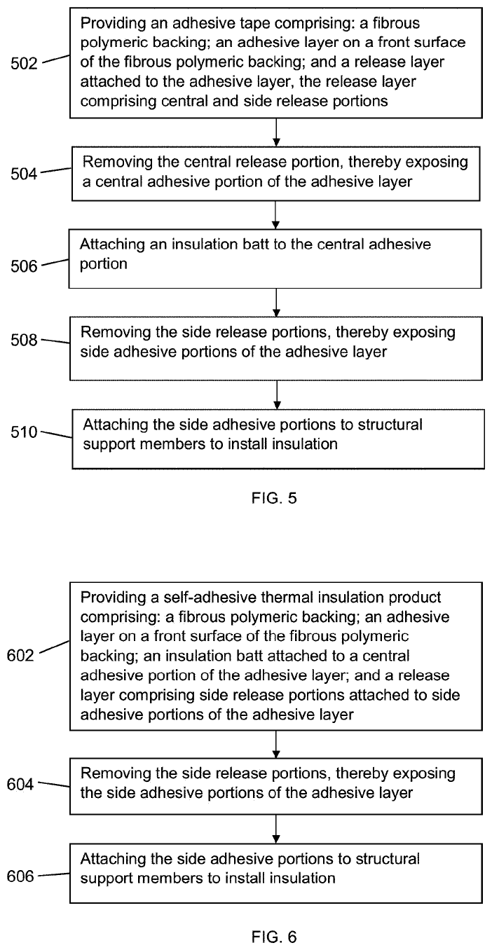

In another example, referring to the flow chart of FIG. 5, the method includes providing 502 an adhesive tape comprising: a fibrous polymeric backing; an adhesive layer on a front surface of the fibrous polymeric backing; and a release layer overlying the adhesive layer, where the release layer may include central and side release portions that are parts of a perforated release layer or are physically separate from each other, such that they may be separately removed. The central release portion may be attached to a central adhesive portion of the adhesive layer and the side release portions may be attached to side adhesive portions of the adhesive layer. The central release portion may be removed 504 first, thereby exposing the central adhesive portion, and an insulation batt may be attached 506 to the central adhesive portion. After attachment of the insulation batt, the side release portions may be removed 508 to expose the side adhesive portions, which may then be attached 510 to structural support members, thereby installing the insulation product. Prior to removing the side release portions, the adhesive tape may be cut to a desired length. The cutting may be carried out before or after attaching the insulation batt.

Referring now to the flow chart of FIG. 6, the method may include, according to another embodiment, providing 602 a self-adhesive thermal insulation product comprising: a fibrous polymeric backing; an adhesive layer on a front surface of the fibrous polymeric backing, where the adhesive layer includes a central adhesive portion and side adhesive portions; an insulation batt attached to the central adhesive portion; and a release layer comprising side release portions attached to the side adhesive portions. The side release portions may be removed 604 to expose the side adhesive portions, which may then be attached 606 to structural support members to install the insulation product.

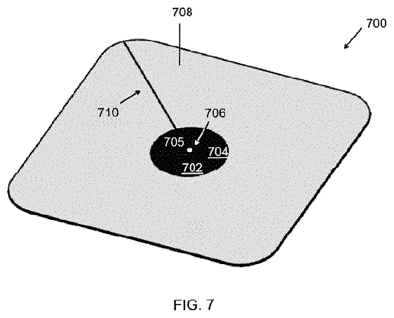

The self-adhesive insulation product may be modified prior to installation to allow for passage of a conduit through the insulation batt and the backing, and an additional adhesive seal 700, as shown in FIG. 7, may be applied to the modified product. Thus, the method may further include, prior to removing the side release portions, creating an opening through the self-adhesive insulation product, and passing a conduit (e.g., pipe, tube, hose, cable, or wire) through the opening and through an expandable hole 706 in the adhesive seal 700. The adhesive seal 700 may then be attached to the self-adhesive insulation product (e.g., to a back surface of the fibrous polymeric backing) to seal off any gaps between the conduit and the modified insulation product.

Referring again to FIG. 7, an adhesive seal 700 is provided. The adhesive seal may include an elastomeric backing 702 with an adhesive coating 704 on a front surface 705 thereof for attachment to the fibrous polymeric backing 102. The front surface 705 defines an expandable hole 706 in the elastomeric backing 702. The expandable hole 706 and surrounding elastomeric backing 702 is capable of stretching to fit around one or more components (e.g., sock-like conformation). Such components include, for example, conduit, electrical components, plumbing components or any other obstruction or component that may be found in a space that may be insulated. Like the adhesive tape 200 and self-adhesive insulation product 100 described above, a release layer 708 may be attached to part or all of the adhesive coating 704 prior to use of the adhesive seal 700. As shown in FIG. 7, the release layer 708 may include a radial cut 710 to promote ease of removal before attaching the adhesive seal 700 to the fibrous polymeric backing of the modified insulation product. The adhesive coating 704 and the release layer 708 may include any of the characteristics described above for the adhesive layer 102 and release layer 108 of the adhesive tape 200 and self-adhesive insulation product 100. The elastomeric backing 702 of the adhesive seal 700 may be fabricated from an suitable material that stretches and fits around one or more components. Suitable materials include, but are not limited to, elastomeric polymer such as butyl rubber (isobutylene-isoprene), isoprene rubber, or another natural or synthetic rubber.

The adhesive tape 200, self-adhesive insulation product 100, and adhesive seal 700 described above may be fabricated using methods known in the art. A commercially available fibrous polymeric backing, such as PET cloth available from Coroplast, may undergo an adhesive coating process, such as a curtain coating process, followed by curing (typically UV curing) to apply the adhesive layer, which as described above may include a UV-crosslinkable polymer. Similarly, in fabricating the adhesive seal, the adhesive coating may be applied to the elastomeric backing using curtain coating methods known in the art followed by curing. In a final step, the adhesive seal may be die cut to the desired size and shape. Suitable exemplary formulations and methods for the adhesive layer or coating are described in U.S. Patent Application Publication No. 2016/0168427, which was incorporated by reference above.

The adhesive layer and/or adhesive coating may have a basis weight in a range from about 100 g/m² to about 200 g/m². The basis weight may be determined as known in the art according to the standard DIN EN ISO 2286-2 entitled “Rubber- or plastics-coated fabrics—Determination of roll characteristics—Part 2: Methods for determination of total mass per unit area, mass per unit area of coating and mass per unit area of substrate.”

When a functional layer is employed between the fibrous polymeric backing and the adhesive layer, the functional layer may be applied to the backing prior to the curtain coating process. According to one embodiment, the functional layer is deposited onto the backing. The functional layer may be deposited by a melt calendering or extrusion process, followed by cooling. Prior to calendering or extruding, the functional layer may be melted or softened by heating to promote flowability. The functional layer may be in the form of beads or another granulated product prior to being melted or softened by heating. According to another embodiment, the functional layer includes one or more water dispersant rubber agent. According to such an embodiment, the polymer filament is dipped into a dispersant agent and then oven dried.

To clarify the use of and to hereby provide notice to the public, the phrases “at least one of <A>, <B>, . . . and <N>” or “at least one of <A>, <B>, <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

Although considerable detail with reference to certain embodiments has been described, other embodiments are possible. The spirit and scope of the appended claims should not be limited, therefore, to the description of the preferred embodiments contained herein. All embodiments that come within the meaning of the claims, either literally or by equivalence, are intended to be embraced therein.

Furthermore, the advantages described above are not necessarily the only advantages, and it is not necessarily expected that all of the described advantages will be achieved with every embodiment.

We claim:

1. A self-adhesive thermal insulation product comprising:
a fibrous polymeric backing;
an adhesive layer on a front surface of the fibrous polymeric backing, the adhesive layer including a central adhesive portion and side adhesive portions;
an insulation batt attached to the central adhesive portion; and
a release layer comprising side release portions attached to the side adhesive portions,
wherein, when the release layer is removed, the side adhesive portions are attachable to structural support members.

2. The self-adhesive thermal insulation product of claim 1, further comprising a functional layer between the fibrous polymeric backing and the adhesive layer, the functional layer having one or more characteristics selected from the group consisting of: abrasion resistance, rigidity, sound-dampening capacity, flame retardance, vapor impermeability, and moisture impermeability.

3. The self-adhesive thermal insulation product of claim 2, wherein the functional layer comprises one or more of a dispersant rubber polymer, a thermoplastic polymer, or a thermosetting polymer.

4. The self-adhesive thermal insulation product of claim 3, wherein the thermoplastic polymer comprises one or more of ethylene-vinyl acetate (EVA), polyethylene (PE), polystyrene (PS), polypropylene (PP), polyvinyl chloride (PVC), linear low-density polyethylene (LLDPE), low-density polyethylene (LDPE), high-density polyethylene (HDPE), or polyethylene (PE).

5. The self-adhesive thermal insulation product of claim 1, wherein the insulation batt further comprises a reflective layer on an opposing surface not attached to the central adhesive portion.

6. The self-adhesive thermal insulation product of claim 5, wherein the reflective layer comprises a metal foil or white film.

7. The self-adhesive thermal insulation product of claim 1, wherein the fibrous polymeric backing comprises a polyester, nonwoven fibers, woven fibers, or a combination thereof.

8. The self-adhesive thermal insulation product of claim 1, wherein the adhesive layer comprises one or more of UV-crosslinkable polymer, acrylic, acrylate or acetate.

9. The self-adhesive thermal insulation product of claim 1, wherein the adhesive layer comprises a basis weight in a range from about 100 g/m² to about 200 g/m².

10. The self-adhesive thermal insulation product of claim 1, wherein the central adhesive portion has a nominal width between the side adhesive portions of about 16 in (41 cm).

11. The self-adhesive thermal insulation product of claim 1, wherein each of the side adhesive portions has a nominal width of about 1 in (2.5 cm).

12. An adhesive tape for home insulation, the adhesive tape comprising:
a fibrous polymeric backing;
an adhesive layer on a front surface of the fibrous polymeric backing;
a release layer comprising central and side release portions, the central release portion being attached to a central adhesive portion of the adhesive layer, and the side release portions being attached to side adhesive portions of the adhesive layer,
wherein, when the central release portion is removed, the central adhesive portion are attachable to an insulation batt, and
wherein, when the side release portions are removed, the side adhesive portions are attachable to structural support members.

13. The adhesive tape of claim 12, wherein the release layer is perforated or scored to define the central and side release portions.

14. The adhesive tape of claim 12, wherein the release layer is a multi-piece release layer, the central and side release portions being separated.

15. The adhesive tape of claim 12, further comprising a functional layer between the fibrous polymeric backing and the adhesive layer, the functional layer having one or more characteristics selected from the group consisting of: abrasion resistance, rigidity, sound-dampening capacity, flame retardance, vapor impermeability, and moisture impermeability.

16. The adhesive tape of claim 15, wherein the functional layer comprises one or more of a dispersant rubber polymer, a thermoplastic polymer, or a thermosetting polymer.

17. The adhesive tape of claim 16, wherein the thermoplastic polymer comprises one or more of ethylene-vinyl acetate (EVA), polyethylene (PE), polystyrene (PS), polypropylene (PP), polyvinyl chloride (PVC), linear low-density polyethylene (LLDPE), low-density polyethylene (LDPE), high-density polyethylene (HDPE), or polyethylene (PE).

18. The adhesive tape of claim 12, wherein the adhesive layer comprises a UV-crosslinkable polymer, a foam-based UV-acrylic, or a combination thereof.

19. An adhesive seal comprising:
an elastomeric backing comprising an adhesive coating on a front surface thereof;
an expandable hole in the elastomeric backing;
a release layer attached to part or all of the adhesive coating;
optionally, a radial cut in the release layer;
wherein the expandable hole and surrounding elastomeric backing are capable of stretching to fit around one or more components.

20. The adhesive seal of claim 19, wherein elastomeric backing comprises an elastomeric polymer selected from the group consisting of butyl rubber (isobutylene-isoprene), isoprene rubber, natural rubber, and synthetic rubber.
